(19) United States
(12) Patent Application Publication
(10) Pub. No.: US 2026/0044110 A1
(43) Pub. Date: Feb. 12, 2026

(54) HOLOGRAPHIC OPTICAL MODULE, HOLOGRAPHIC DISPLAY DEVICE COMPRISING SUCH A HOLOGRAPHIC OPTICAL MODULE, AND METHOD FOR PRODUCING SUCH A HOLOGRAPHIC OPTICAL MODULE

(71) Applicant: Carl Zeiss Jena GmbH, Jena (DE)

(72) Inventors: Viktor SCHUETZ, Kahla (DE); Petr VOJTISEK, Jena (DE); Roman KLEINDIENST, Weimar (DE)

(21) Appl. No.: 18/872,164

(22) PCT Filed: Jun. 2, 2023
(86) PCT No.: PCT/EP2023/064817

§ 371 Date: Dec. 5, 2024

(30) Foreign Application Priority Data
Jun. 8, 2022 (DE) 10 2022 114 381.3

(51) Int. Cl. G03H 1/00; G03H 1/30

(52) U.S. Cl. CPC G03H 1/0005; G03H 1/30; G03H 2001/0088; G03H 2001/306; G03H 2223/14; G03H 2270/32; G03H 2270/55

(57) ABSTRACT

A holographic optics module having a main body having a first surface, and two or more area elements each having a holographic structure is provided, wherein the two or more area elements are arranged on the first surface of the main body such that they form a coherent area that provides a predetermined optical function.

### PRIORITY

This application claims the priority of German patent application DE 10 2022 114 381.3 filed Jun. 8, 2022, which is hereby incorporated herein by reference in its entirety.

### FIELD

The present invention relates to a holographic optics module, to a holographic display device comprising such a holographic optics module, and to a method of producing such a holographic optics module.

### BACKGROUND

There is the constantly growing need for large-area display devices that are used, for example, in transparent surfaces, such as large window surfaces, corresponding panes in vehicles or, for example, in glass-door refrigerators in retail.

Conventional display devices in retail are LCD- or OLED-based, but are generally integrated televisions in the corresponding articles, for example items of furniture. These are firstly not transparent. They are secondly very costly and demanding of build space, since it is necessary also to provide the electronics for the display.

Transparent OLED displays already exist. But these are very costly and are therefore unusable for economic reasons in many sectors.

It is also known that holographic structures on transparent surfaces can provide desired optical properties. For example, it is thus possible thereby to create diffuser surfaces that can be utilized for image representation. However, the production of such holographic structures is costly and time-consuming, with a disproportionately large increase in costs and time taken with the size of the desired holographic structures.

### SUMMARY

An object of the invention is to provide an optics module which is usable in display devices and with which the difficulties discussed can be avoided as far as possible. Furthermore, a display device having such an optics module and a method of producing such an optics module are to be provided.

Since a coherent area is formed from the two or more area elements in the holographic optics module, there is firstly no limit in principle to the size of the coherent area thus formed. On the other hand, the production of such a holographic optics module is possible at lesser expense and more quickly since the area elements can be produced by replicating a master hologram. This brings the advantage that the replicating of a master hologram can be performed much more quickly than the production of the necessary master hologram. The replicating of the master hologram is also much cheaper than the production of the master hologram itself. A time and cost benefit is thus achieved, which means that larger coherent areas can also be produced quickly and inexpensively.

A coherent area here especially means that the multiple area elements are arranged edge-to-edge, in a partly overlapping manner or at a distance from one another of less than 50%, 40%, 30%, 20%, 10%, 9%, 8%, 7%, 6%, 5%, 4%, 3%, 2%, 1%, 0.5% or 0.1% as a maximum extent of one of the area elements. The maximum extent, for example in the case of a rectangular area element, is a diagonal that connects two corners.

In addition, it is possible that the coherent area is not coherent in all regions. For example, it may thus also have gaps. However, there is always an arrangement of at least two, three, four, five, six, seven, eight, nine, ten or more area elements such that they form a coherent area.

The arranging of the two or more area elements on the first surface of the main body here especially means that individual area elements, that at least one individual area element and at least one already coherent part-area having two or more area elements, or that two or more already coherent part-areas having two or more area elements are arranged on the first surface.

The first surface of the main body is especially a surface of a one-piece main body or a one-piece portion of the main body. The first surface may especially be of continuous and smooth design. The first surface may preferably be formed without discontinuities, edges and/or depressions. The first surface of the main body (and especially of the one-piece main body or of the one-piece portion of the main body) is preferably larger than each of the two or more area elements in terms of area. The first surface is especially a surface which is not composed of two or more part-areas. The first surface preferably takes the form of a one-piece surface and/or of a single surface.

The main body may take the form, for example, of a two-dimensional body. In particular, the main body may take the form of a plate. For instance, the main body may take the form of a plane-parallel plate or else of a curved plate.

It is a particular feature of a plate-shaped form of the main body that the main body has at least one two-dimensional front face, a two-dimensional rear face, and an edge (or end face) that connects the front face and reverse face and, because of the plate-shaped design of the main body, has a smaller (in particular much smaller) areal extent than the front face and reverse face. It can also be stated that the distance between front face and reverse face and hence the height of the main body is lower (for example less than 10%) than the extent (e.g. length and width in the case of a rectangular shape of front face and reverse face or, for example, diameter in the case of a circular shape of front face and reverse face) of front face and reverse face. The front side or reverse side may be the first surface of the main body.

The main body is preferably transparent. The main body may have been produced, for example, from glass or plastic. The main body may take the form of a glass pane or of a plastic pane. In particular, the main body may take the form of a window surface or pane, or of a glazing element for vehicles or for electric ovens, refrigerators, freezers, washing machines, dryers, dishwashers, etc. (for example in retail or in a domestic setting).

The main body may have one, two, three or more plate bodies that are arranged in a stack and joined to one another. The main body may take the form, for example, of a multipane insulation glass composed of two or more plate bodies (or panes).

If the main body has two or more plate bodies, each plate body has a two-dimensional front face and a two-dimensional reverse face, and an edge (or end face) that connects the front face and reverse face and, because of the plate-shaped design of the plate body, has a smaller (in particular much smaller) areal extent than the front face and reverse face. Each of these front and reverse faces may be the first surface of the main body.

Each area element may take the form of a film or foil, for example. The material used for such a film or for such a foil may, for example, be plastic (e.g. polycarbonate or polyethylene terephthalate). The area elements may take the form of a single-ply or multi-ply film or of a single-ply or multi-ply foil. The holographic structure of each area element may take the form, for example, of a holographic film. This may form the area element on its own. But the holographic film may also be bonded to a further foil or embedded between two foils, so as to then result in a two-ply or three-ply area element. It is of course possible that the area element has more than three plies, for example four or five plies. The total thickness of each area element may be in the range from 50 μm to 2 mm.

In the holographic optics module, at least two of the area elements may be arranged on the first surface without overlap. It is possible here for the at least two area elements to be arranged edge-to-edge on the first surface or with a join between the two area elements on the first surface. The join may be filled with an optical cement in order to form a smooth area element surface. The cement preferably has a refractive index matched to the two area elements.

It is also possible that a first area element is disposed on the first surface with an overlap of a second area element. In this case, the optical functions provided by means of the holographic structure of the first and second area elements may be reduced in the overlap region such that the predetermined optical function in the overlap region is provided by the two reduced optical functions.

In addition, there may be a space between the first area element and the first surface in the region of the second area element owing to the overlap. The space is preferably filled with an optical cement, which especially has a refractive index matched to the first optical element.

In addition, at the edge of the first area element, in the region in which the first area element lies against the second area element, there may be disposed an optical cement in order that a stepped edge is avoided thereby, and there is more of a continuous transition.

In the holographic optics module, the area elements may be fixed on the first surface by adhesion on the first surface or by a bonding means (for example an optical cement). The optical cement may especially have a refractive index matched to the area elements.

The area elements may all have the same shape and size. The result is thus parqueting (forming of the coherent areas) with area elements that all have the same shape and size.

It is of course also possible that parqueting is conducted with area elements having two or more different shapes and sizes. The area elements may be polygons. In particular, the area elements may have straight-line edges. However, it is also possible that the area elements have curved edges.

The main body may be transparent. It may also be nontransparent. The first surface may be planar. It is also possible that the first surface is of curved design.

The holographic optics module may be transmissive or reflective.

In the holographic optics module, the holographic structures of two, three, four, five, six, seven, eight, nine, ten or more area elements (or of a plurality of the area elements) may each provide the same optical function (or the same optical functionality). It is also possible that the holographic structures of all area elements of the holographic optics module provide the same optical function (or the same optical functionality). In that case, the area elements together form the coherent area having the predetermined optical function.

The optical function (or the optical functionality) may, for example, be a diffuser function, such that the two or more area elements form a coherent diffuser area.

In addition, the holographic structures of two, three, four, five, six, seven, eight, nine, ten or more area elements may have different optical functionalities (in particular mutually matched optical functionalities), in order then to together form the coherent area having the predetermined optical function.

It is of course possible for the holographic structures of two or more area elements to have different optical functionalities and those of two or more area elements to have the same optical functionalities (in particular mutually matched optical functionalities), in order then to together form the coherent area having the predetermined optical function.

The predetermined optical function of the coherent area may, for example, be the optical function of a lens (for example a spherical and/or aspherical lens, a converging lens or a diverging lens).

The holographic display device may have a holographic optics module as provided herein, an image module that creates an image, and an imaging optics unit that reproduces the image created by the image module on the holographic optics module, where the holographic optics module acts as a diffuser surface, where the image formed is perceptible as a real image (as a so-called in-plane image). Thus, the real image is perceptible as an image in the plane of the diffuser surface.

The image module may especially be a digital protector having an LCD or LCoS module or a tilted mirror matrix, for example, as image generator.

The imaging optics may have spherical and/or aspherical imaging elements (especially lenses).

In the method for producing a holographic optics module, in a first step, at least one master hologram having an optical functionality is produced. In a second step, the master hologram(s) for production of two or more area elements is/are replicated (preferably multiple times), where the area elements in each case all have a holographic structure having the same optical functionality as that of the (respective) master hologram. In a third step, two or more area elements are arranged on a first surface of a main body such that the two or more area elements form a coherent area that provides a predetermined optical function.

The (respective) master hologram and the area elements produced by replication thereby may be formed in any suitable material, for example in a polymer material. It is possible to use, for example, a PC foil (polycarbonate foil) or a PET foil (polyethylene terephthalate foil) having a holographic film in which the master hologram and/or the area elements produced therewith by replication are created. The holographic film may especially be embedded between two such foils (e.g. polymer foils), where the total thickness may be in the range from 50 μm to 2 mm.

The arranging of the two or more area elements on the first surface of the main body here especially means that individual area elements, that at least one individual area element and at least one already coherent part-area having two or more area elements, or that two or more already coherent part-areas having two or more area elements are arranged on the first surface.

It will be apparent that the features mentioned above and the features still to be elucidated hereinafter can be used not only in the specified combinations but also in other combinations or on their own, without departing from the scope of the present invention.

The invention will be elucidated in detail hereinafter on the basis of working examples with reference to the accompanying drawings, which likewise disclose features essential to the invention. These working examples serve for illustrative purposes only and should not be interpreted in a limiting manner. For example, a description of a working example comprising a multiplicity of elements or components should not be interpreted as meaning that all these elements or components are necessary for implementation. Instead, other working examples may also contain alternative elements and components, fewer elements or components, or additional elements or components. Elements or components from different working examples can be combined with one another, unless stated otherwise. Modifications and variations that are described for one of the working examples may also be applicable to other working examples. In order to avoid repetition, identical or corresponding elements in different figures are denoted by the same reference signs and are not explained repeatedly.

### BRIEF DESCRIPTION OF THE DRAWINGS

FIG. 1 is a schematic section view of a holographic display device integrated in a glass-door refrigerator;

FIG. 2 is a schematic front view of the holographic display device integrated in the glass-door refrigerator from FIG. 1;

FIG. 3 is a diagram for elucidation of the construction of the diffuser hologram from the two or more area elements;

FIG. 4 is a schematic view for elucidation of the method of producing the area elements;

FIGS. 5 to 8 are diagrams for elucidation of possible parqueting for provision of the diffuser hologram;

FIGS. 9 to 12 are section views for elucidation of various embodiments of the arrangement of the area elements on the first surface;

FIG. 13 is a schematic diagram for elucidation of the efficiency progression of the optical diffuser functions provided by the area elements in the overlap region, and

FIG. 14 is a diagram for elucidation of possible implementation of a lens function in a diffuser hologram.

### DETAILED DESCRIPTION

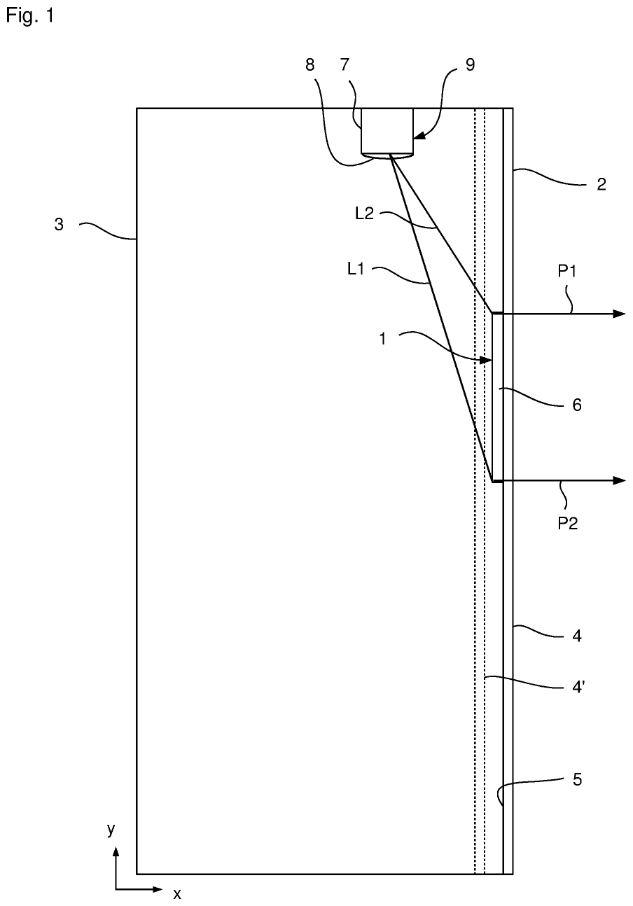

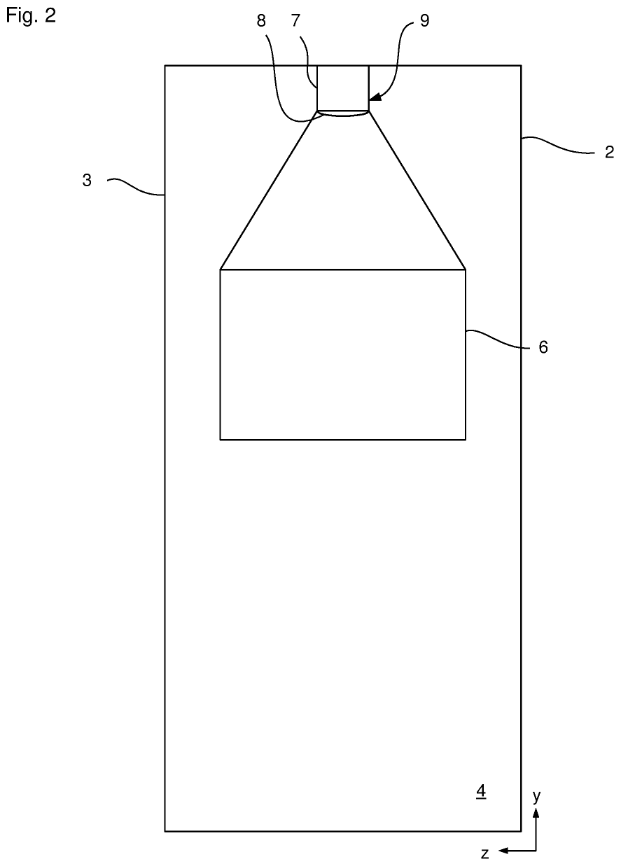

An inventive holographic optics module 1 may take the form, for example, of a glass door 2 of a glass-door refrigerator 3, as shown schematically in FIGS. 1 and 2.

The glass door 2 comprises a glass pane 4, on the inside 5 of which is disposed a diffuser hologram 6. The glass pane 4 may also be referred to as a main body 4, where the inside 5 is a first surface 5 of the main body 4.

Also disposed in the glass-door refrigerator 3 are an image module 7 that creates an image, and imaging optics 8 that reproduces the image created on the diffuser hologram 6 (indicated schematically by two light rays L1 and L2 in FIG. 1). As indicated by the arrows P1 and P2 in FIG. 1, the diffuser hologram 6 performs a deflection of the light rays L1, L2 such that they run essentially at right angles through the glass pane 4, where a predetermined solid angle range is covered by the light rays L1, L2, such that the image created by the image module 7 is visible on the diffuser hologram 6 to an observer standing in front of the glass-door refrigerator 3. The diffuser hologram 6 thus acts as a focusing screen for an image created by the image module 7 and it is preferably transparent when no image from the imaging module 7 is being reproduced on the diffuser hologram 6. The diffuser hologram 6 may, as apparent in FIGS. 1 and 2, have an essentially rectangular shape with, for example, a dimension of 700×580 mm.

The optics module 1 together with the imaging module 7 and the imaging optics 8, which may take the form of a digital projector for example, forms a holographic display device 9.

The glass pane 4 may also take the form of double glazing (in this case the glass pane 4 comprises two plate bodies that are formed from glass here), and in that case comprises the inner pane 4′shown by dashed lines. In that case, the diffuser hologram 6 may be disposed in the interspace between the two panes, as shown schematically in FIG. 1.

The diffuser hologram 6 is formed from two or more area elements 10, all of which have the same holographic diffuser structure and are arranged on the inside 5 of the glass pane 4 such that they form a coherent area that then provides the desired diffuser function.

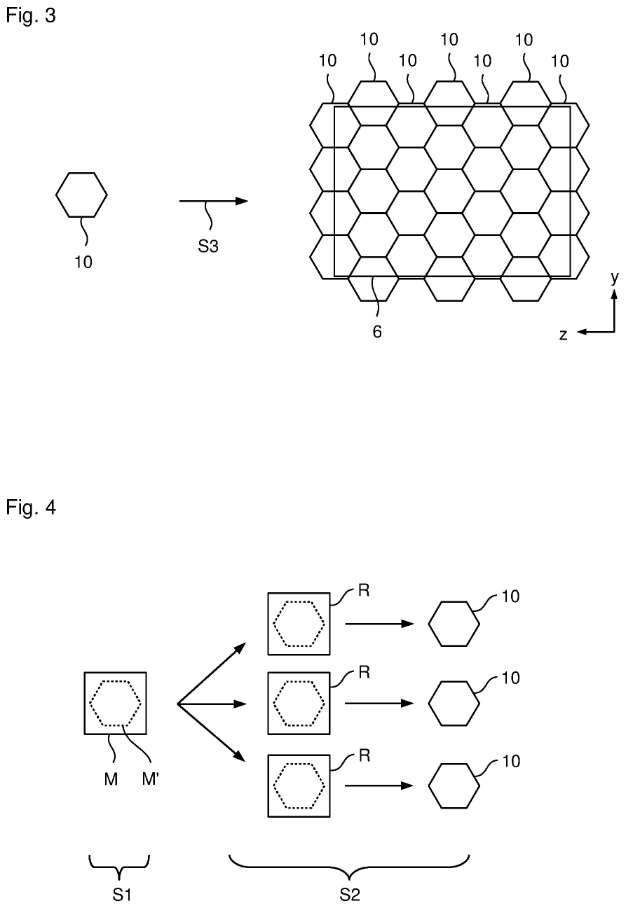

As shown in FIG. 3, the area element 10 may take the form of a hexagon (for example of a regular hexagon). Such hexagons can form a coherent area when the hexagons 10 are arranged in the manner shown in FIG. 3.

For production of the area elements 10, in a first step S1, a master hologram M having the desired optical function or functionality (diffuser function) is written (FIG. 4). The master hologram M may be written in an area region fully encompassed by the shape of the desired area element 10, as indicated by the dashed hexagon M'. Alternatively, it is possible that the master hologram M already has the desired shape of the area elements 10 to be produced (the hexagonal shape M′ here).

In a subsequent replication step S2, the master hologram M or M′ is replicated (FIG. 3 shows three replications R in a representative manner) until the number of area elements 10 required is satisfied (step S2). If necessary, the replication step S2 includes cutting the replicas R to size in order to obtain the desired area pieces 10.

The master hologram M or M′ and the replicas R may be formed in any suitable material, for example polymer material. It is possible to use, for example, a PC foil (polycarbonate foil) or a PET foil (polyethylene terephthalate foil) having a holographic film in which the master hologram M or M′ or the corresponding replica R are produced. The holographic film may especially be embedded between two such foils, where the total thickness may be in the range from 50 μm to 2 mm.

Thereafter, the area elements 10 may be arranged on the inside 5 of the glass pane 4 in a stitching step S3 such that the entire region of the desired hologram 6 is filled by the area elements 10 (FIG. 3).

The great advantage in this procedure is that the replication step S2 for copying a master hologram (M or M′) is much shorter than step S1 of writing a master hologram M or M′. It is thus possible, for example, to greatly reduce the production time for the hologram 6 described. A conventional digital exposure for such a size currently takes at least two weeks for the abovementioned hologram size. Given an edge length of the regular hexagons in the range from 3 to 6 cm, the duration for production of the hologram 6 by means of steps S1-S3 can be reduced to from about four days down to about one day.

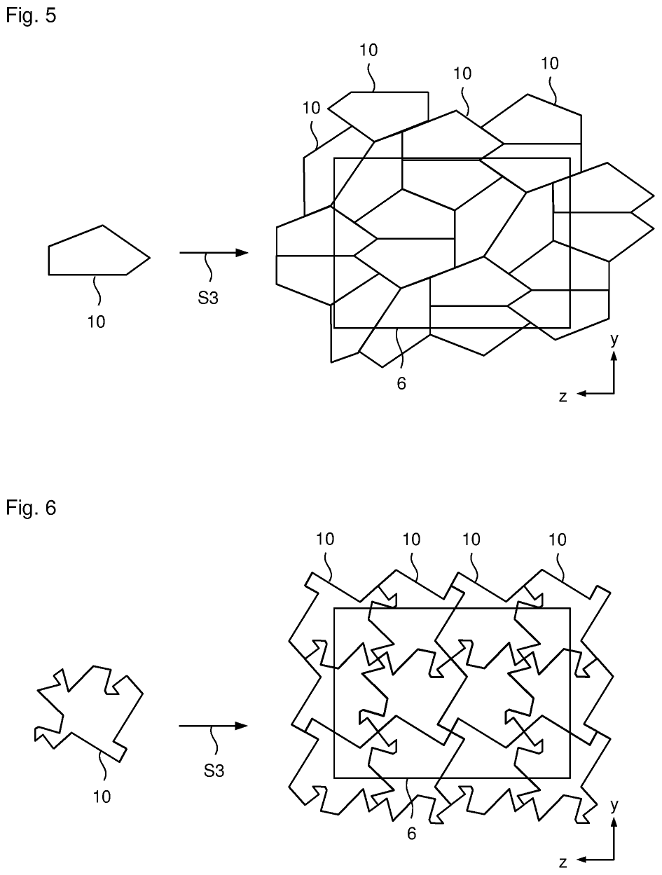

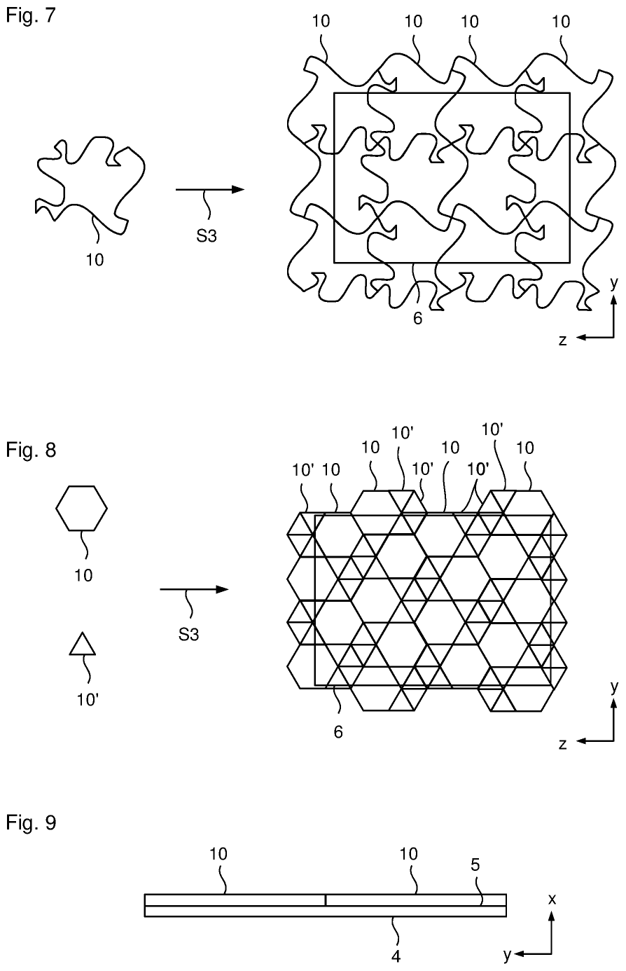

The shape of the area element 10 is preferably chosen such that a coherent area can be formed with a single shape and size, as shown by way of example for the regular hexagon in FIG. 3. However, for example, pentagons (FIG. 5) and other shapes having straight edges or else curved edges (FIGS. 6 and 7) are also possible.

It is also possible to assemble the hologram 6 from two or more different area elements. In FIG. 8, this is indicated by way of example for two different area elements (hexagon 10 and triangle 10′).

The area elements 10 may, as shown schematically for two area elements 10 in FIG. 9, be arranged on the inside 5 of the glass pane 4 such that their end faces abut one another.

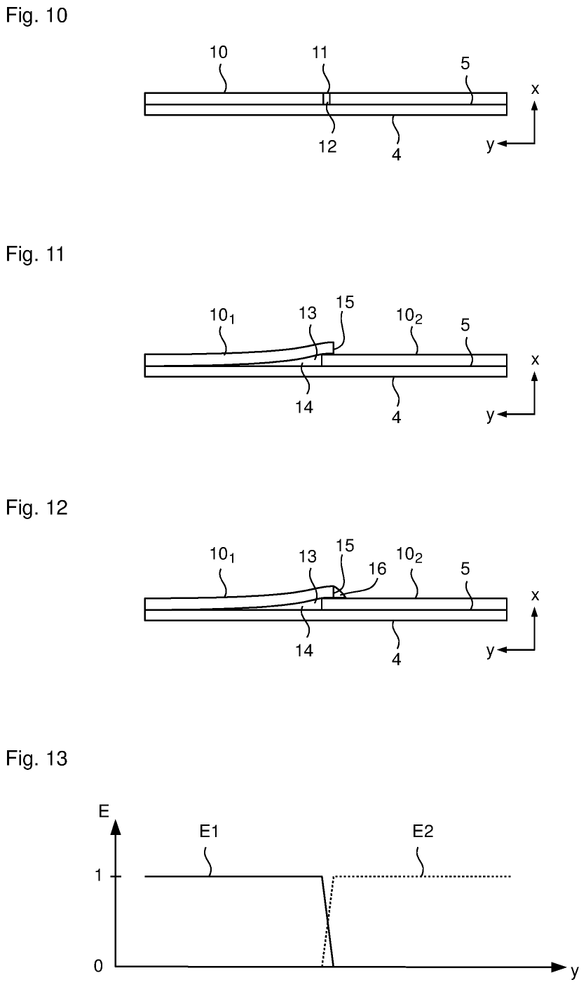

Alternatively, it is possible, as shown in FIG. 10, that there is a gap 11 between the end faces of two directly adjacent area elements 10. The gap 11 is preferably filled with an optical cement 12 which has a refractive index matched to the area elements 10.

In addition, it is possible, as shown schematically in FIG. 11, that two directly adjacent area elements 10₁, 10₂ partly overlap. This gives rise to a space 13 beneath the first area element 10₁ which is partly overlapped by the second area element 10₂. This space 13 is in turn preferably filled with an optical cement 14 having a refractive index matched to the refractive index of the area elements 10₁, 10₂.

FIG. 12 shows a development of the arrangement according to FIG. 11. In this development, an optical cement 15 is also provided in the region of the end face 15 of the first area element 10₁ of the region positioned atop the second area element 10₂ such that there is a very substantially continuous transition to the top side of the second area element 10₂, and so there is no edge resulting from the end face 15 on the top side of the area elements. This is advantageous in order to avoid unwanted scatter at such an edge.

The first and second area elements 10₁ and 10₂ (and especially all area elements 10), when they are arranged in an overlapping manner as indicated in FIGS. 11 and 12 on the inside 5 of the glass pane 4, may be designed such that the efficiency E1 and E2 of the holographic diffusion function of the area elements 10₁ and 10₂ decreases in the overlap region, as shown schematically in FIG. 13. The efficiencies E1 and E2 are then summated in the overlap region, such that the efficiency is also the same therein as outside the overlap region by virtue of the area elements 10₁, 10₂. This is shown merely in schematic form in FIG. 13, where efficiency E is plotted in arbitrary units between 0 and 1, and the y coordinate was adopted as location coordinate.

By virtue of production of the diffuser hologram 6 from smaller area elements 10, the size of the diffuser hologram 6 is unlimited in principle. If a larger diffuser hologram 6 is desired, there is merely an arrangement of more area elements 10 on the inside 5 of the glass pane 4.

Of course, the embodiment of the diffuser hologram 6 on the inside 5 of the glass pane 4 of a glass-pane refrigerator 3 is merely illustrative. Such a diffuser hologram 6 may be formed on any other surfaces, for example large window surfaces or on corresponding glass surfaces of vehicles, for example cars or trucks.

The diffuser hologram 6 described is transmissive. Of course, a reflective design of the diffuser hologram 6 is also possible.

Moreover, the hologram 6 need not take the form of a diffuser hologram, but may implement any other optical function, for example a lens function. Advantageously, the optical functions implemented are those in which the individual area elements 10 each have the same optical function and are thus identical in terms of their optical function.

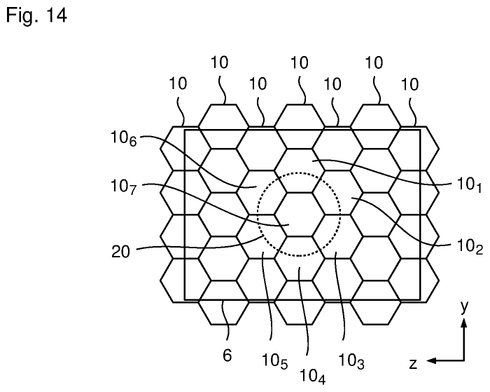

A diffuser hologram 6 having a lens function in a predetermined region 20 is shown schematically, for example, in FIG. 14, where the predetermined region 20 is indicated by a dashed circle. In general, the optical properties of the area elements 10₁-10₇ that implement the lens function are different, such that different master holograms M are required. In the example shown here, the lens function of a converging lens with spherical interfaces is to be implemented, such that a first master hologram can be used for each of the area elements 10₁-10₆ and a different second master hologram for the area element 10₇.

Of course, it is also possible that more than two different area elements 10₁-10₇ have to be produced. It is also possible for all area elements 10₁-10₇ to be different, such that the same number of master holograms is needed (for example as separate master holograms).

In the embodiments according to FIGS. 3 to 7 that have been described to date, only one type of area element 10 (same size and same shape) has been used to form a large-area hologram 6. However, it is also possible that the area elements 10, 10′have two or more different shapes and/or sizes, as described, for example, in conjunction with FIG. 8.

In addition, it is possible that the coherent area is not coherent in all regions. For example, it may thus also have gaps.

The area elements 10, 10′may be fixed by adhesion on the inside 5 of the glass pane 4. However, it is also possible that they are fixed on the inside 5 by means of an optical cement. In this case, the refractive index of the optical cement is again preferably matched to the refractive index of the area elements 10, 10′.

The glass pane 4 is thus a main body having a first surface, where the area elements 10, 10′ are disposed on the first surface. The main body is preferably transparent. However, it may also be of nontransparent design. The first surface 5 may be planar. However, it is also possible that the first surface 5 is curved.

The first surface 5 may be an outer surface of the holographic optics module 1 which is then thus formed. However, it is also possible that a further layer (preferably a transparent layer) is formed on the area elements 10, 10′.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products. Moreover, features or aspects of various example embodiments may be mixed and matched (even if such combination is not explicitly described herein) without departing from the scope of the invention.

1-16. (canceled)

17. A holographic optics module, comprising:
a main body having a first surface; and
two or more area elements, each of which comprising a holographic structure,
wherein the two or more area elements are arranged on the first surface of the main body such that they form a coherent area that provides a predetermined optical function.

18. The holographic optics module of claim 17, wherein at least two of the two or more area elements are arranged on the first surface without overlap.

19. The holographic optics module of claim 17, wherein a join is formed between at least two of the two or more area elements, wherein the join is filled with optical cement in order to form a smooth area element surface, and where the optical cement has a refractive index matched to the at least two of the two or more area elements.

20. The holographic optics module of claim 17, wherein at least two of the two or more area elements are arranged edge-to-edge on the first surface.

21. The holographic optics module of claim 17, wherein a first area element overlapping with a second area element are arranged on the first surface.

22. The holographic optics module of claim 21, wherein the optical functions provided via a holographic structure of the first and second area elements are reduced in a region of the overlap such that the predetermined optical function in the region of the overlap is provided by the two reduced optical functions.

23. The holographic optics module of claim 21, wherein a space in a region of the second area element between the first area element and the first surface, owing to the overlap, is filled with an optical cement having a refractive index matched to the first area element.

24. The holographic optics module of claim 17, wherein at least two of the two or more area elements are fixed with optical cement on the first surface of the transparent main body, and wherein the optical cement has a refractive index matched to the at least two of the two or more area elements.

25. The holographic optics module of claim 17, wherein at least two of the two or more area elements have the same shape and size.

26. The holographic optics module of claim 17, wherein the holographic structures of two or more of the area elements (10, 10′) each provide the same optical function.

27. The holographic optics module of claim 17, wherein the holographic structures of at least two of the two or more of the area elements provide different optical functions.

28. The holographic optics module of claim 17, wherein the predetermined optical function comprises a two-dimensional diffuser function.

29. The holographic optics module of claim 17, wherein the predetermined optical function of the coherent area comprises a lens function.

30. The holographic optics module of claim 17, wherein the main body comprises at least one plate body comprising a two-dimensional front side and a two-dimensional reverse side, and an edge which connects the front side and reverse side and has a smaller areal extent than the front side and reverse side because of the plate-shaped design of the plate body, and wherein the front side or reverse side is the first surface of the main body.

31. A holographic display device, comprising:
the holographic optics module of claim 17;
an image module that creates an image; and
an imaging optics unit that reproduces the image created by the image module on the holographic optics module, which acts as a diffuser surface,
wherein the reproduced image is perceptible as a real image in the plane of the two or more area elements.

32. A method of producing a holographic optics module, comprising:
producing at least one master hologram having an optical functionality;
replicating the master hologram(s) for production of two or more area elements, which all have in each case a holographic structure,
arranging the two or more area elements on a first surface of a main body such that the two or more area elements form a coherent area that provides a predetermined optical function.
